(19) United States
(12) Patent Application Publication
(10) Pub. No.: US 2025/0283551 A1
(43) Pub. Date: Sep. 11, 2025

(54) VALVE FOR CONTROLLING THE FLOW OF A FLUID

(71) Applicant: FESTO SE & CO. KG, Esslingen (DE)

(72) Inventors: Sebastian MÜLLER, Walddorfhäslach (DE); Heiko PATZ, Weilheim (DE); Tamás SZILI, Esslingen (DE)

(21) Appl. No.: 18/862,366

(22) PCT Filed: Apr. 28, 2023
(86) PCT No.: PCT/EP2023/061274

§ 371 Date: Nov. 1, 2024

(30) Foreign Application Priority Data
May 4, 2022 (DE) 10 2022 110 949.6

(51) Int. Cl. F16K 31/06; F16K 1/42

(52) U.S. Cl. CPC F16K 31/0655; F16K 1/42; F16K 31/0675; F16K 2200/302

(57) ABSTRACT

A valve which includes a valve housing in which a valve member is positioned which can be positioned in a closed position and in a maximum open position as part of a lifting movement which can be caused by a drive apparatus. A spring apparatus causes the valve member to reach an intermediate open position when the drive apparatus is deactivated. The spring apparatus contains a closing spring acting in the closing direction and an opening spring acting in the opening direction, the spring forces of which are matched to one another in such a way that the intermediate open position forms a basic position of the valve.

This application claims priority to DE 10 2022 110 949.6, filed 4 May 2022, which is incorporated herein by reference.

### BACKGROUND OF THE INVENTION

The invention relates to a valve for controlling the flow of a fluid, comprising a valve housing which delimits a valve chamber into which a feed channel for feeding in fluid and a working channel enabling a fluid outlet open, wherein a feed channel opening of the feed channel is framed by a valve seat facing the valve chamber, opposite which valve seat in the valve chamber there is a closing surface positioned on an axial front side of a valve member of the valve, wherein the valve member is movable in the axial direction of a main axis of the valve by a lifting movement, which is caused by a driving force of a drive apparatus of the valve, and which lifting movement is oriented in the axial direction of a main axis, in a closed position, in which the valve bears with its closing surface against the valve seat and thereby separates the feed channel from the valve chamber in a fluid-tight manner, or in at least one open position raised from the valve seat and thereby releasing a fluid connection between the feed channel and the valve chamber in permanent fluid connection with the working channel, and wherein the valve member is constantly biased in the direction of the closed position by a closing spring of a spring apparatus of the valve.

A valve of this type known from DE 10 2013 011 759 A1 comprises a valve member which is pretensioned by a closing spring into a closed position in which it rests within a valve chamber against a valve seat surrounding a feed channel opening, thereby preventing fluid from entering the valve chamber from a feed channel. By actuating an electric drive apparatus based on an electrodynamic operating principle, the valve member can be moved into at least one open position raised from the valve seat and held in this open position so that a pressurized fluid fed into the feed channel can overflow into the valve chamber and flow out of the valve chamber through a working channel leading to a consumer. As the valve member takes up the closed position when the drive apparatus is deactivated, it is a valve of the “Normally Closed” type. Due to the required power consumption, such a valve has energy disadvantages in applications that regularly require a much longer maintenance of an open position compared to maintaining a closed position, as the drive apparatus must be activated for a correspondingly long time. A valve described in WO 2017/080602 A1 is subject to the same issue.

Electrically actuated valves of the “Normally Closed” type are also described in DE 2 208 183 A1, DE 297 23 707 U1, DE 10 2014 220 222 A1, EP 0 611 349 B1 and EP 0 698 738 B1.

EP 1 959 177 B1 and U.S. Pat. No. 6,367,766 B1 describe valves of the “Normally Open” type, which take up an open position that allows fluid flow when the drive apparatus is deactivated. Here, however, particularly high drive forces must be applied to maintain the closed position, since not only the spring force of an opening spring constantly acting in the opening direction must be overcome, but also the fluid pressure acting on the valve member in the opening direction. Using a weaker spring to remedy the problem could possibly no longer guarantee safe opening when the drive apparatus is deactivated. A reduction in the opening force due to the fluid pressure could only be achieved with a significantly reduced nominal diameter and correspondingly lower flow values.

### SUMMARY OF THE INVENTION

It is the object of the invention to take measures that enable energy-saving and reliable operation of a valve while allowing high flow rates.

This object is solved by a valve in conjunction with the features mentioned at the beginning in that, in addition to the closing spring, the spring apparatus has an opening spring which constantly biases the valve member in the direction of the at least one open position, wherein the closing spring and the opening spring, which acts in the opposite direction in this respect, are mutually coordinated with respect to their spring forces in such a way that the valve member takes up a basic position without driving forces of the drive apparatus, which basic position is an intermediate open position lying between the closed position and a maximum open position.

In this way, a valve is present whose type can be described as “Normally Partially Open”. The spring apparatus, which comprises both a closing spring and an opening spring, holds the valve member in an open position known as the intermediate open position when the drive apparatus is deactivated, i.e. when no drive forces are exerted on the valve member by the drive apparatus, in which fluid flow from the feed channel into the valve chamber is possible, albeit at a lower flow rate than in the maximum open position. The intermediate open position of the valve member is a stroke position in which the closing forces generated by the closing spring and the opening forces generated by the opening spring equalize, resulting in a quasi-zero force point. In order to close or further open the valve from the intermediate open position, opposing drive forces are required from the drive apparatus, although these are lower than the drive forces required for a pure “Normally Closed” valve or a pure “Normally Open” valve of comparable nominal size.

In principle, the valve can be configured as a valve actuated by fluid power, in particular pneumatically, with a correspondingly configured drive apparatus. However, preferred is a valve configuration whose drive apparatus is of an electrically actuatable type and which can be referred to as an electric drive apparatus. In particular, an electrodynamic drive apparatus based on Lorentz forces, or an electromagnetic drive apparatus based on reluctance forces is used.

In order to close the valve in an electrically actuated drive apparatus starting from the intermediate open position of the valve member, it is preferable to generate a current in a coil apparatus of the drive apparatus, which generates a force acting in the closing direction and presses the valve member against the spring force of the opening spring acting in the opening direction against the valve seat. To reopen the valve from the closed position, the drive force acting to close the valve can be reduced or removed. When the intermediate open position is reached, the direction of current flow in the coil apparatus can be reversed so that a drive force acting in the opening direction is generated, which now acts against the closing spring and opens the valve further beyond the intermediate open position.

As the valve member has to be moved from the intermediate open position by less than the maximum possible lift for the closing process, the drive forces to be applied are correspondingly low, so that there is no risk of overheating due to the electrical energy input, even with a large nominal width. The same applies to holding the valve member in any open position beyond the intermediate open position, wherein there is also a cooling effect caused by the fluid flowing through.

In an embodiment considered to be particularly favorable, the drive apparatus comprises a first drive component formed by an electrical coil apparatus and a second drive component interacting with the electrically powered coil apparatus to generate a driving force acting on the valve member in the axial direction of the main axis. One of these two drive components is positioned on the valve member, the other on the valve housing. In this way, for example, a solenoid valve can be realized or preferably an electrodynamic operating principle realized as a solenoid plunger principle or as a moving coil principle.

Preferably, the valve comprises a control electronics configured to control the drive apparatus. In conjunction with an electric drive apparatus, the control electronics is configured in particular in such a way that it can generate an electrical power to the drive apparatus which has either an opening current direction acting on the valve member or a closing current direction acting on the valve member, so that the valve member can be closed or opened further starting from the intermediate open position by selecting a corresponding current direction. If a lifting movement over the full lift between the closed position and the maximum open position is desired, the control electronics can reverse the current direction when passing through the intermediate open position.

Preferably, the control electronics of the valve can be used to electrically power the drive apparatus in both current directions with variable current intensity. In this way, any partial open position between the closed position and the maximum open position can be continuously adjusted. Such a valve can preferably be operated as a proportional valve.

In particular, the control electronics is integrated into the valve housing or attached to the outside of it. However, it can also be realized as a separate component. For example, it contains a circuit board fitted with a microprocessor.

In order to enable precise adjustment of a desired lifting position and, accordingly, a desired flow rate, it is preferable for the valve to comprise a position detection apparatus by means of which lifting positions of the valve member that can be reached during the lifting movement of the valve member can be detected. In particular, the position detection apparatus is connected to the optional control electronics, which can process the valve member position data supplied by the position detection apparatus as feedback information.

Preferably, the control electronics has a closed-loop control functionality. In this way, closed-loop position control of the drive apparatus is possible on the basis of the position data obtained by means of the position detection apparatus. The position detection apparatus expediently has at least one Hall sensor or another measuring apparatus for determining the stroke position, wherein the other measuring apparatus can also be configured for laser-based or ultrasound-based position detection, for example. The position detection apparatus is expediently equipped with the functionality of a displacement measuring system configured for continuous position detection.

Preferably, the two springs of the spring apparatus acting in opposite directions on the valve member are configured with respect to force in such a way that the valve member in the intermediate open position takes up at least essentially a half-open position, in which the flow cross-section available for the fluid passing through the feed channel opening is approximately or exactly half as large as a maximum flow cross-section released in the maximum open position of the valve member.

In particular, in the intermediate open position, the valve member reaches a lifting position in which it is only just above the closing point at which the closing surface of the valve member touches the valve seat fixed to the housing.

Both the closing spring and the opening spring are expediently each a compression spring. Such a configuration is preferred to that of a return spring. In particular, both the closing spring and the opening spring are coil springs.

In order to preset the desired intermediate open position, the closing spring and the opening spring are expediently configured such that they have force-displacement characteristics and/or winding pitches that are matched to one another and in particular differ from one another.

A configuration in which the closing spring and the opening spring are configured as separate individual springs of the spring apparatus is considered to be particularly advantageous. This favors the coordinated configuration of the spring forces on both sides and enables a particularly space-saving accommodation in the valve housing, in particular in that the opening spring coaxially encloses the closing spring, or vice versa.

Alternatively, the spring apparatus could have only a single spring element which is gripped by the valve member at a point located between its two end regions, wherein the gripping point is selected according to the desired spring force ratio. The intermediate tapping can be realized, for example, by attaching the valve member to the single spring element at the relevant point, wherein the length sections of the one-piece spring element axially adjoining the tapping point on both sides act as an opening spring in one case and as a closing spring in the other case.

In a configuration regarded as favorable, the valve member comprises a hat-shaped anterior end section which comprises a front ground wall carrying the closing surface, a sleeve-shaped sidewall extending axially away from the inner feed channel opening starting from the ground wall, and an annular disc-shaped support wall projecting radially outwards from the sidewall at an axial distance from the front ground wall. In this case, the closing spring is positioned so that it is enclosed by the sleeve-shaped sidewall and is supported on the one hand on the ground wall of the valve member and on the other hand on a housing-fixed support body positioned axially opposite the ground wall. The opening spring is positioned so that it surrounds the sleeve-shaped sidewall and is supported axially on the valve housing inside the valve chamber on the one hand and on the support section of the valve member on the other. The sleeve-shaped sidewall is located radially between the closing spring and the opening spring, wherein the closing spring is enclosed by the opening spring over at least part of its overall length in a coaxial arrangement.

Preferably, the valve member is made of several parts and comprises a one-piece valve member base body, on which a preferably disk-shaped sealing element is positioned on the front side facing the inner feed channel opening as a further component of the valve member, which defines the closing surface cooperating with the valve seat.

The closing surface of the valve member is preferably formed on a sealing element consisting of a rubber-elastic material.

In principle, the invention can be realized with valves of any functionality. The embodiment according to the invention proves to be particularly advantageous in conjunction with a 2/2-way valve. The invention can be implemented both in pure switching valves and in proportional valves.

The valve seat can be formed directly on the valve housing. Preferably, it has a collar-like, axially raised structure, wherein it defines an annular sealing edge against which the closing surface rests in the closed position of the valve member.

According to an advantageous embodiment of the invention, the valve seat is located on a sleeve-shaped valve seat element which is separate from the valve housing, is aligned coaxially to the main axis and is inserted into an inner end section of the feed channel with a variable axial position relative to the main axis and is fixed to the housing. During assembly of the valve, the axial position of the valve seat element with respect to the valve housing can be variably adjusted and fixed axially immovable to the valve housing in the set target position. For example, the valve seat element can be pressed into the end section of the feed channel with variable press-fit depth. Additionally or alternatively, adhesive fixing or screw fixing could also be considered. The variability of the axial position during valve assembly offers the advantage of being able to perform a calibration in order to compensate for both the geometric component tolerances and the spring tolerances. If the valve has an electric drive apparatus, the valve seat element and consequently the valve seat can be moved within the valve housing during calibration, for example, until a desired flow rate is achieved for a given electric current.

It is particularly advantageous to provide special pressure compensation measures with regard to the valve member in order to realize relatively large nominal diameters and still keep the drive forces to be applied low. In this respect, it is preferable if the valve member has a compensation surface which is oriented axially in the opposite direction to the closing surface and which compensation surface delimits a compensation chamber formed in the valve housing, which compensation chamber constantly communicates with the region axially upstream of the closing surface via at least one compensation channel passing through the valve member. This means that the fluid pressure in the area upstream of the closing surface and in the compensation chamber is always at least essentially the same, resulting in compensation of the pressure force acting axially on the valve member.

At least essentially complete pressure compensation is possible if, in an advantageous manner, the compensation surface of the valve member is at least essentially and preferably exactly the same size as the area of the inner feed channel opening that can be covered by the valve member, i.e., the area framed by the valve seat. The pressure force compensation is effective both in the closed position and in any open position of the valve member. As a result, the valve member can be forced to its lifting movement with a very low driving force and held in the respective lifting position.

### BRIEF DESCRIPTION OF THE DRAWINGS

The invention is explained in more detail below with reference to the enclosed drawing. It shows:

FIG. 1 a preferred embodiment of the valve according to the invention in a longitudinal section, wherein the valve member is shown taking up the intermediate open position and wherein the lifting positions taken up by the valve member in the closed position and in the maximum open position are additionally indicated by dotted lines, and

FIG. 2 an isometric exploded view of the valve illustrated in FIG. 1.

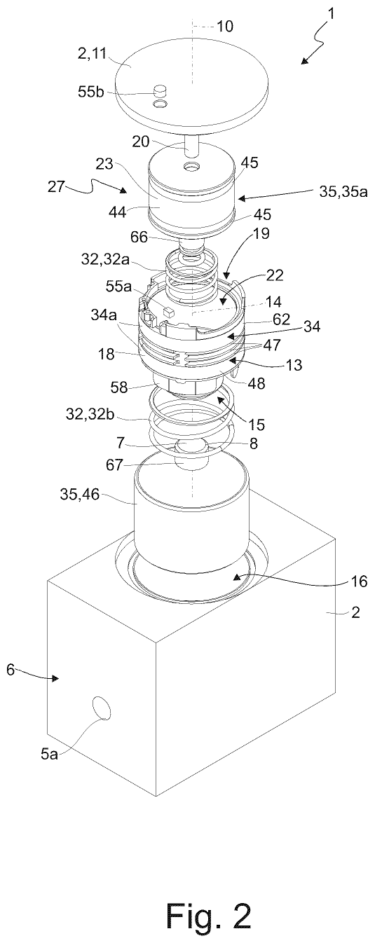

### DETAILED DESCRIPTION

The valve designated in its entirety by reference number 1 has a valve housing 2, which is preferably made up of several parts and comprises a valve chamber 3 in its interior.

Several valve channels 4, 5 which pass through the valve housing 2 and through which a fluid can flow open into the valve chamber 3; these are, by way of example, a feed channel 4 and a working channel 5. At its opposite end region, the feed channel 4 opens out via an outer connection opening 4a and the working channel 5 opens out via an outer connection opening 5a to an outer surface 6 of the valve housing 2, so that in particular it is possible to connect a further fluid line to each.

During operation of the valve 1, the feed channel 4 is connected via its outer connection opening 4a to an external pressure source P, which provides a pressurized fluid, wherein this is in particular compressed air.

During operation of the valve 1, the working channel 5 is in fluid connection via its outer connection opening 5a with a consumer A, which is, for example, a fluid-actuated actuator.

The valve 1 makes it possible to control a fluid flow between the feed channel 4 and the working channel 5, namely through the valve chamber 3. The valve 1 allows either shutting off, i.e., closing the fluid connection between the feed channel 4 and the valve chamber 3, or opening this fluid connection with the result that the pressurized fluid can flow from the feed channel 4 through the valve chamber 3 into the working channel 5.

The feed channel 4 opens into the valve chamber 3 with an inner channel opening, referred to below as feed channel opening 7 for better differentiation. The feed channel opening 7 is located in the area of a ground surface 3a of the valve chamber 3 and is framed by an annular valve seat 8 facing the valve chamber 3. The valve seat 3 is expediently configured in a collar-shaped raised form with respect to a surface section of the ground surface 3a surrounding it.

The valve 1 has an imaginary main axis 10. The feed channel opening 7 and the valve seat 8 are aligned in the axial direction of this main axis 10, wherein they are positioned in particular coaxially thereto. The ground surface 3a extends in particular in a plane orthogonal to the main axis 10.

The working channel 5 opens into the valve chamber 3 distanced from the feed channel opening 7 and, in particular, laterally, wherein its corresponding channel opening is referred to as working channel opening 12. While the fluid connection between the valve chamber 3 and the working channel 5 is permanently open, the fluid connection between the feed channel 4 and the valve chamber 3 can be controlled by means of a valve member 13 of the valve 1.

While the valve 1 of the embodiment example is designed as a 2/2-way valve, a design with a different valve functionality is also possible, for example with a 3/2 valve function. In such cases in particular, the valve 1 can easily have one or more additional valve channels which open into the valve chamber 3.

Preferably, the valve member 13 has an elongated shape and, by way of example, has an imaginary longitudinal axis 14 that coincides with the main axis 10.

In the embodiment example, the valve chamber 3 is formed by the axial end region of a blind-hole-like reception recess 16 of the valve housing 2, into which the valve member 13 is inserted. The valve member 13 has an axial front side 15 with which it faces the valve chamber 3. The valve member 13 also has an axial rear side 19 opposite the axial front side 15 in the axial direction of the main axis 10.

The reception recess 16 is bounded axially on the inside by a ground surface 16a formed on the valve housing 2, which forms the ground surface 3a of the valve chamber 3. On the outside axially opposite the ground surface 16a, the reception recess 16 is closed by a closing element 11, for example a lid-shaped closing element, of the valve housing 2. The valve member 13 is located axially between the ground surface 3a, 16a and the closing element 11, wherein it delimits the valve chamber 3 on a side axially opposite the ground surface 16a.

The valve member 13 comprises an axially oriented end surface on its axial front side 15, which forms a closing surface 26 facing the feed channel opening 7 and the valve seat 8. Upon actuation of a drive apparatus 27 of the valve 1, the valve member 13 can be caused to perform a linear lifting movement 28, which is oriented in the axial direction of the main axis 10 and is illustrated in the drawing by a double arrow. The valve member 13 can be moved either in a first direction of movement 28a pointing forwards in the direction of the valve seat 8 or in a second direction of movement 28b pointing backwards in the opposite direction in the sense of moving away from the valve seat 8. For this purpose, the drive apparatus 27 can exert a correspondingly oriented drive force on the valve member 13.

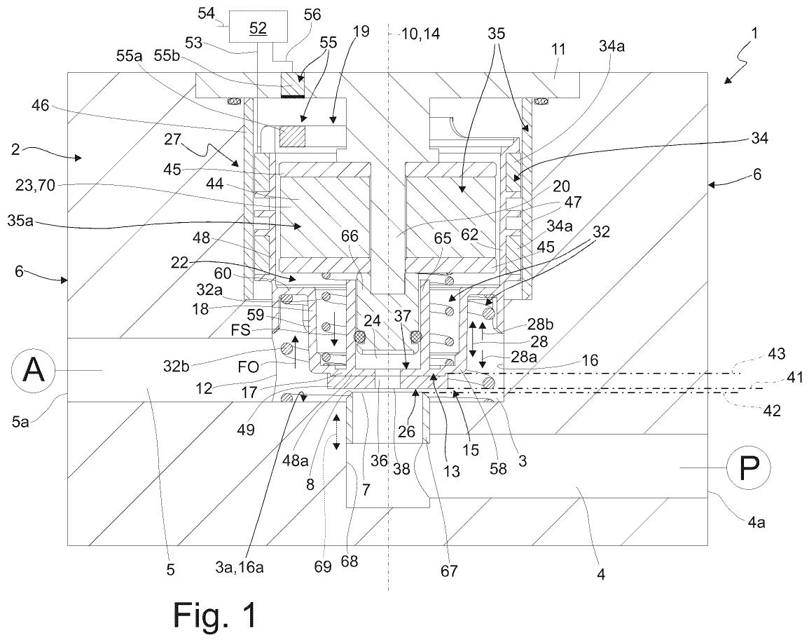

Within the lifting movement 28, the valve member 13 can be positioned in different lifting positions. One of these lifting positions is an open position shown in FIG. 1 and additionally indicated by a dotted line, referred to as intermediate open position 41, in which the valve member 13 is lifted with its closing surface 26 from the valve seat 8, albeit by an amount that is less than a possible maximum amount.

Other possible lifting positions of the valve member 13 are a closed position 42 and an open position designated as maximum open position 43, each of which is also indicated by a dotted line in FIG. 1.

In the closed position 42, the valve member 13 rests with its closing surface 26 against the valve seat 8 with sealing and at the same time covers the feed channel opening 7. In this way, the feed channel 4 in the closed position 42 of the valve member 13 is separated in a fluid-tight manner from the valve chamber 3 and the working channel 5 permanently connected to it.

The distance measured in the axial direction of the main axis 10 between the valve seat 8 and the closing surface 26, which is also referred to as the axial distance, determines a free flow cross-section that is available to the fluid or the fluidic pressure medium for the transition between the feed channel 4 and the valve chamber 3. The free flow cross-section determines the flow rate of the overflowing fluid, which can also be referred to as the flow rate.

In the maximum open position 43 of the valve member 13, the closing surface 26 is positioned at the greatest possible axial distance from the valve seat 8. This maximum axial distance is greater than the axial distance between the closing surface 26 and the valve seat 8 in the intermediate open position 41.

In the maximum open position 43 of the valve member 13, the fluidic pressure medium fed into the feed channel 4 has a released maximum flow cross-section for passing into the valve chamber 3. In the intermediate open position 41 of the valve member 13, the released flow cross-section is smaller than the maximum flow cross-section.

By actuating the drive apparatus 27 accordingly, the valve member 13 can optionally be positioned at least in the closed position 42, in the maximum open position 43 or in the intermediate open position 41.

If the valve 1 is configured as a switching valve, the movability of the valve member 13 is preferably limited to these three lifting positions. Preferably, however, the valve 13 is configured as a continuously adjustable proportional valve in accordance with the illustrated embodiment example, wherein the valve member 13 can be positioned not only in the intermediate open position 41—in particular steplessly—but also in any other open positions between the closed position 42 and the maximum open position 43, which can be designated as partial open positions. In any of these other partial open positions, the distance between the closing surface 26 and the valve seat 8 is greater or smaller than in the intermediate open position 41.

The exemplary valve member 13 has a pot-like shape with a ground wall 17 associated with the axial front side 15 and a hollow cylindrical sidewall 18 projecting from the ground wall 17 in the direction of the axial rear side 19. The pot shape defines a valve member interior 22 facing away from the valve chamber 3 and also separated in this respect.

The valve 1 is equipped with a spring apparatus 32, which is integrated between the valve member 13 and the valve housing 2 as far as the flow of force is concerned. The spring apparatus 32 holds the valve member 13 in the intermediate open position 41 when the drive apparatus 27 mentioned above does not exert any driving forces on the valve member 13. In other words, the intermediate open position 41 represents a basic position of the valve member 13, which the valve member 13 takes up when the drive apparatus is deactivated. The valve 1 is therefore (only) partially open when the drive apparatus 27 is deactivated, so that it can be described as a valve of a new type “Normally Partially Open”.

This functionality results from a special configuration of the spring apparatus 32. The spring apparatus 32 has a closing spring 32a on the one hand and an opening spring 32b on the other. The closing spring 32a is a spring that constantly acts on the valve member 13 in the direction of the closed position, for example in the first direction of movement 28a, with a spring force that can be designated as closing force FS. The opening spring 32b is a spring that constantly acts on the valve member 13 in the opening direction, for example in the second direction of movement 28b, with a spring force that can be designated as opening force FO. The valve member 13 is therefore constantly acted upon in opposite directions of the main axis 10 by spring forces FS, FO, which are provided on the one hand by the closing spring 32a and on the other hand by the oppositely acting opening spring 32b.

The closing spring 32a and the opening spring 32b, which are also referred to simply as springs 32a, 32b when named together, are matched to each other with regard to their spring forces FS, FO in such a way that the valve member 13 takes up the described basic position, i.e. the intermediate open position 41, without any effective drive forces from the drive apparatus 27. In the basic position or intermediate open position 41, there is a balance of forces between the two springs 32a, 32b on the valve member 13, so that one can speak of a force zero point, since no resulting spring forces act on the valve member 13 in the axial direction of the main axis 10.

Each of the two springs 32a, 32b is supported on the valve member 13 on the one hand and directly or indirectly on the valve housing 2 on the other.

Although it would in principle be possible to realize one or both of the springs 32a, 32b as compression springs, they are expediently mechanical springs 32a, 32b according to the illustrated embodiment example.

According to the illustrated embodiment example, the drive apparatus 27 is preferably of electrically actuated configuration. By applying an electrical actuating voltage, the drive apparatus 27 can cause a driving force acting on the valve member 13 in the axial direction of the main axis 10, which, by overcoming the spring forces FS, FO of the two springs 32a, 32b, causes a lifting movement 28 of the valve member 13 in the first direction of movement 28a or the second direction of movement 28b and by means of which the valve member 13 can be held in a set lifting position for as long as desired. The drive force of the drive apparatus 27 is added to the closing force FS or the opening force FO, depending on the direction of action.

Preferably, the electrically actuable drive apparatus 27 comprises a first drive component 34 and a second drive component 35 interacting with the first drive component 34 to generate the driving force. One of the two drive components 34, 35 is positioned on the valve member 13, the other of the two drive components 34, 35 is positioned on the valve housing 2. As an example, the first drive component 34 is positioned on the valve member 13 and the second drive component 35 on the valve housing.

One of the two drive components 34, 35 is expediently configured as an electrical coil apparatus 34a that can be electrically powered by applying the aforementioned actuating voltage. The lifting position currently taken by the valve member 13 relative to the valve seat 8 depends on the level and polarity of the actuating voltage applied to the electrical coil apparatus 34a. The selected polarity determines a current direction of the electric current flowing through the coil apparatus 34a and, accordingly, the effective direction of the drive force that can be generated.

By way of example, the first drive component 34 is the coil apparatus 34a. As an example, it is positioned at the valve member 13 and is supported in particular by its sidewall 18. It therefore always participates in the lifting movement 28. When electrically powered, the coil apparatus 34a cooperates with the second drive component 35, which is stationary with respect to the valve housing 2.

Preferably and according to the illustrated embodiment example, the drive apparatus 27 is an electrodynamic drive apparatus 27. In this case, the second drive component 35 comprises a permanent magnet apparatus 35a, which cooperates with the coil apparatus 34a according to the electrodynamic operating principle.

As an example, the permanent magnet apparatus 35a enters the valve member interior 22 from the axial rear side 19. It sits, for example, on a support projection 20 of the closing element 11, which projects centrally into the reception recess 16 and is, for example, rod-shaped. In particular, the permanent magnet apparatus 35a consists of at least one ring magnet 44, which is coaxial with the main axis 10 and is flanked axially on both sides by an annular ferromagnetic forward conductance disk 45.

Preferably, the second drive component 35 also contains a ferromagnetic guiding sleeve 46 which is stationary relative to the valve housing 2, is inserted coaxially into the reception recess 16 and encloses the valve member 13 radially on the outside. The guiding sleeve 46 expediently functions simultaneously as a guide element for radial support and linear guidance of the valve member 13 during the lifting movement 28. Preferably, the valve member 13 has a plurality of axially spaced-apart annular collar-like guiding fins 47 on the radial outside, which bear against the inner circumferential surface of the guiding sleeve 46 in a slidingly displaceable manner. The coil apparatus 34a, which has at least one coil section 48 consisting of wound wire, is conveniently positioned axially between the guiding fins 47.

When the coil apparatus 34a is electrically powered, the charge carriers flowing in it co-operate with the permanent magnetic field of the permanent magnet apparatus 35a, resulting in the so-called Lorentz force, which acts as a driving force for the valve member 13. The current direction determines the effective direction of the Lorentz force and consequently the driving force, while the current strength determines the level of the driving force.

As an example, the electrodynamic drive apparatus 27 is configured as a plunger coil drive. However, a configuration as a plunger magnet drive with an interchanged arrangement of the two drive components 34, 35 and a permanent magnet apparatus 35a that participates in the lifting movement 28 is also possible.

According to an embodiment example, the second drive component 35 is designed as a ferromagnetic apparatus instead of a permanent magnet apparatus 35a, which interacts with the coil apparatus 34a according to the reluctance principle.

It is understood that other configurations of drive apparatuses 27 can also be provided for actuating the valve member 13.

Preferably, the valve member 13 is made up of several parts, wherein it has a particularly one-piece valve member base body 48, which is equipped on the axial front side 15 with a sealing element 49 consisting of an elastomer material or another rubber-elastic material. As an example, the aforementioned pot shape of the valve member 13 is determined by the shape of the valve member base body 48. The ground wall 17 of the valve member 13 is composed of a base section 48a of the valve member base body 48 and the sealing element 49 attached to the front outside of this base section 48a.

The sealing element 43 is preferably disk-shaped. According to the embodiment example, it is buttoned into the base section 42a, but can additionally or alternatively also be glued or welded in place, for example. In any case, the elastically flexible sealing element 43 is supported in the axial direction of the main axis 10 by the base section 42a of the valve member base body 42.

The closing surface 26 is formed on the sealing element 43. Expediently, the closing surface 26 is limited to a central area of the forward-facing front end face of the sealing element 49. The outer diameter of the sealing element 49 is larger overall than the outer diameter of the closing surface 26. In this respect, the closing surface 26 is framed by an annular surface section of the front end face of the sealing element 49, which extends radially outwards to a radial outer circumferential surface of the sealing element 49.

Expediently, the valve 1 contains a control electronics 52 designed to electrically control the drive apparatus 27. The control electronics 52, which is only indicated schematically, is expediently integrated into the valve housing 2, wherein it can either be mounted on the valve housing 2 or positioned separately in this respect.

The control electronics 52 is configured to electrically power the drive apparatus 27 and is connected to the coil apparatus 34a via at least one electrical control cable 53. The control cable 53 is in particular flexible so that the permanent magnet apparatus 35a can follow the lifting movement 28 unhindered. The control electronics 52 can generate the variable electrical powering already explained with varying current strength and varying current direction. Operating information for the control electronics 52 can be entered at an electrical input 54 of the control electronics 52, in particular target position information for a desired lifting position of the valve member 13.

Expediently, the valve 1 is equipped with a position detection apparatus 55, which is also only schematically indicated and which contains, by way of example, a permanent magnet 55a positioned on the movable valve member 13 and a Hall sensor 55b positioned in a fixed position on the valve housing 2 and there, for example, on the closing element 11. By interacting with the permanent magnet 55a, the Hall sensor 55b is able to detect lifting positions of the valve member 13 that can be adopted during the lifting movement 28, wherein in particular a stepless detection of each lifting position including the closed position is possible. The position detection apparatus 55 is electrically connected to the control electronics 52 via at least one feedback cable 56 in order to supply it with the determined position data.

The control electronics 52 expediently comprises a closed-loop control functionality that enables position-closed-loop-controlled actuation of the drive apparatus 27 and accordingly allows very precise positioning of the valve member 13 in the desired target lifting positions.

The spring apparatus 32 acting on the valve member 13 is preferably configured such that, in the intermediate open position, the valve member 13 releases a flow cross-section for the fluid passing through the feed channel opening 7 that is at least essentially and preferably exactly half as large as a maximum flow cross-section released in the maximum open position of the valve member. In the non-actuated operating state, the valve 1 is half open in this case. However, it is understood that the spring apparatus 32 can be configured differently in accordance with the respective application in order to keep a specifically desired flow cross-section open in the intermediate open position.

The desired configuration of the spring apparatus 32 can be achieved simply by selecting matching force-displacement characteristics and/or winding pitches for the closing spring 32a and the opening spring 32b. For example, the two springs 32a, 32b are configured differently from one another, in particular such that the closing spring 32a has a steeper spring characteristic curve than the opening spring 32b.

The force-related configuration of the spring apparatus 32 is exemplarily favored by the fact that the closing spring 32a and the opening spring 32b are separate, individual springs 32a, 32b of the spring apparatus 32. In this way, each spring 32a, 32b can be manufactured and provided as a separate component independently of the other spring 32b, 32a. In principle, however, it is possible to provide a single one-piece spring element as spring apparatus 32, which is connected to the valve member 13 at a point that is spaced apart from the two axial spring ends and can be designated as a tapping point, so that one of the length sections of the spring element axially adjoining the tapping point on both sides forms the closing spring 32a and the other forms the opening spring 32b.

Preferably, both springs 32a, 32b are configured as compression springs. This applies to the illustrated embodiment example just as much as an advantageous configuration of both springs 32a, 32b as helical springs. Accordingly, as an example, both the closing spring 32a and the opening spring 32b are configured as helical compression springs. This is associated with the advantageous possibility of making a coaxial arrangement of the two springs 32a, 32b, which is also realized in the embodiment example, wherein one of the two springs 32a, 32b coaxially encloses the other of the two springs 32b, 32a at least over a partial length. In other words, the two springs 32a, 32b overlap in the axial direction of the main axis 10.

As an example, the Closing spring 32a has a smaller diameter than the Opening spring 32b, wherein the Opening spring 32b encloses the Closing spring 32a with radial clearance.

An anterior end section 58 of the valve member 13, which comprises the closing surface 26, preferably has a hat-shaped configuration. The anterior end section 58 includes the preferably circularly contoured ground wall 17, a sleeve-shaped sidewall 59 extending from the edge of the ground wall 17 in the direction of the axial rear side 19 and thus axially away from the feed channel opening 7, and an annular disk-shaped support wall 60 positioned at an axial distance from the ground wall 17 in a coaxial arrangement on the sidewall 59 and projecting radially outwards from the sidewall 59.

The sleeve-shaped sidewall 59 and the support wall 60 are components of the sidewall 18 of the overall pot-shaped valve member 13. The support wall 60 is adjoined towards the axial rear side 19 by a sleeve-shaped holding wall 62, which also forms a section of the sidewall 18 and which bears the first drive component 34.

Together with the sleeve-shaped sidewall 59, the ground wall 17 delimits a longitudinal section of the valve member interior 22. The closing spring 32a is positioned in this valve member interior 22 and is therefore enclosed radially on the outside by the sleeve-shaped sidewall 59. It bears on the one hand on the inner surface of the ground wall 17 of the valve member 13 axially opposite the closing surface 26 and on the other hand on a support body 23 fixed to the housing axially opposite the ground wall 17. As an example, the support body 63 is advantageously formed by the permanent magnet apparatus 35a.

The opening spring 32b is located inside the valve chamber 3 outside the valve member interior 22, wherein it encloses the sleeve-shaped sidewall 59. It bears on the valve member 13 on the one hand and on the valve housing 2 on the other in the axial direction of the main axis 10. Preferably, the bearing is provided on the surface of the support wall 60 facing the ground surface 16a with respect to the valve member 13 and on the ground surface 16a of the reception recess 16 with respect to the valve housing 2.

During operation of the valve 1, the valve member 13 takes the basic position shown in the drawing and defining an intermediate open position 41 when the drive apparatus 27 is deactivated due to a lack of drive forces. Starting from this basic position, the valve member 13 can be moved in the direction of the closed position 42 by overcoming the opening spring force FO of the opening spring 32b or in the direction of the maximum open position 43 by overcoming the closing spring force FS of the closing spring 32a, depending on the direction of electrical powering of the coil apparatus 34a controlled by the control electronics 52.

If, starting from the closed position 42 or starting from the maximum open position 43, a full lift is required to switch to the other extreme position, the control electronics 52 causes a reversal of the current direction in the coil apparatus 34a when passing through the intermediate open position 41.

Starting from the closed position 42, the control electronics 52 initially cause a reduction in the drive force acting in the first direction of movement 28a, wherein after overcoming the force zero point located in the intermediate open position 41, the direction of current in the coil apparatus 34a is reversed, so that a drive force acting in the second direction of movement 28b is created. Starting from the maximum open position 43, this operating sequence takes place in reverse.

The maximum open position of the valve member 13 is preferably defined by the fact that the valve member 13 comes to rest against a stop 70 fixed to the housing during its lifting movement 28 in the second direction of movement 28b. The valve member 13 is pressed against the stop 70 by a correspondingly high drive force of the drive apparatus 27. Expediently, the stop 70 is formed by the support body 23. The closed position results from the contact of the closing surface 26 with the valve seat 8 during the lifting movement 28 taking place in the first direction of movement 28a.

Preferably, the valve 1 is equipped with members which compensate the feed fluid pressure present via the feed channel 4 on the valve member 13 in order to keep the actuating forces for switching and holding the valve member 13 as low as possible. These compensation members include a compensation surface 37 formed on the valve member 13 and oriented axially opposite to the closing surface 26, which in the embodiment example is formed on the rear side of the ground wall 17 and delimits a compensation chamber 24 formed by a partial space of the valve member interior 22. The compensation chamber 24 communicates with the area in the valve housing 2 axially upstream of the closing surface 26 via a fluid channel referred to as compensation channel 36 due to its mode of operation.

As an example, the compensation chamber 24 is radially bounded by a sleeve-shaped chamber wall 65, which is a component of the valve member 13 and projects away from the ground wall 17 in the direction of the axial rear side 19. It is coaxially surrounded by the sleeve-shaped sidewall 59. Between the sleeve-shaped chamber wall 65 and the sleeve-shaped sidewall 59 there is an annular space in which the closing spring 32a extends. On the rear side facing axially away from the ground wall 17, the compensation chamber 24 is closed by a closing body 66, which is fixed to the housing and in particular is piston-shaped, and which rests against the inner circumferential surface of the sleeve-shaped chamber wall 65, which is axially movable with respect to the closing body 66, with dynamic sealing. As an example, the closing body 66 is positioned on the end face of the support projection 20.

In particular, the compensation channel 36 passes through the ground wall 17 of the valve member 13, wherein it communicates with the compensation chamber 24 at the rear and opens out to the closing surface 26 at its front via a compensation opening 38. In this way, the fluid pressure prevailing in the area upstream of the closing surface 26 is picked up by the compensation channel 36, which therefore also prevails at the same level in the compensation chamber 24. Consequently, the same pressure is applied to the closing surface 26 and the compensation surface 37, so that the pressure forces are compensated. It is particularly advantageous if the compensation surface 37 is at least essentially and in particular exactly the same size as the cross-sectional area of the feed channel opening 7 framed by the valve seat 8.

It is expedient if measures are taken with valve 1 that enable simple compensation of any geometric component tolerances and/or spring tolerances during manufacture. These measures are a corresponding calibration option. Calibration can be carried out by moving the valve seat 8 relative to the valve housing 2 in the axial direction of the main axis 10 in order to change the axial distance to the ground surface 16a.

In a calibration procedure that can be carried out during the manufacture of the valve 1, the valve seat 8 is axially displaced until a desired flow rate is reached at a given current intensity of the electric current flowing through the coil apparatus 34a, which is measured during the calibration procedure.

The movability of the valve seat 8, which enables calibration, is exemplarily realized by the fact that the valve seat 8 is formed on the end face of a sleeve-shaped valve seat element 67 which is separate from the valve housing 2 and aligned coaxially to the main axis 10. The valve seat element 67 is inserted into an inner end section 68 of the feed channel 6 opposite the outer connection opening 4a with a variable axial position in relation to the axial direction of the main axis 10 and is fixed to the housing. During calibration, the valve seat element 67 can be moved relative to the valve housing 2 in the axial direction of the main axis 10 as part of a calibration movement 69 indicated by a double arrow and, in particular, can be moved linearly. In the operational, completed state of the valve 1, the position of use of the valve seat element 67 set in relation to the valve housing 2 is blocked so that no undesired changes in position can occur.

As an example, the valve seat element 67 is pressed into the inner end section 68 of the feed channel 4 with a variable press-fit depth and fixed in a force-fit manner. Alternatively or additionally, an adhesive connection can be provided for fixing. It is also possible, for example, to configure the valve seat element 67 as a screw element with an external thread that is screwed into an internal thread formed in the inner end section 68. In this case, the threaded connection is permanently blocked in a suitable manner when the desired position of use is reached during calibration.

In an advantageous calibration process, the coil apparatus 34a is electrically powered by means of the control electronics 52 or an external power source with a predetermined current intensity and a predetermined current direction, so that the valve member 13 takes a certain lifting position based on the sum of the actuating forces acting on it, i.e. the driving force generated by the applied current as well as the closing force FS and the opening force FO of the two springs 32a, 32b, whereupon the valve seat element 67 is moved in the axial direction of the main axis 10 relative to the valve housing 2 by the calibration movement 69 until a desired flow rate is achieved. Any flow sensor is used to measure the flow rate during calibration.

To summarize again briefly, in the illustrated embodiment example, the valve member 13 is constantly acted upon by the closing spring 32a with a spring force acting in the first direction of movement 28a, referred to as closing force FS, and by the opening spring 32b with a spring force acting in the second direction of movement 28b, referred to as opening force FO. The intermediate open position 41 of the valve member 13 is located where the closing force FS and the opening force FO are equal, taking into account the spring characteristics of the two springs 32a, 32b. This means that the intermediate open position 41, which acts as the basic position, can be preset as desired by a correspondingly coordinated configuration of the two springs 32a, 32b. This can be done in particular as part of a calibration during the manufacture of the valve 1.

The valve 1 can optionally be equipped with adjustment members that allow the spring preload of the closing spring 32a and/or the opening spring 32b to be subsequently changed in order to be able to vary and adjust the basic position as required even after the valve 1 has been completed.

1. A valve for controlling the flow of a fluid, comprising a valve housing which delimits a valve chamber into which a feed channel for feeding in fluid and a working channel enabling a fluid outlet open, wherein a feed channel opening of the feed channel is framed by a valve seat facing the valve chamber, opposite which valve seat in the valve chamber there is a closing surface positioned on an axial front side of a valve member of the valve, wherein the valve member is movable in the axial direction of a main axis of the valve by a lifting movement, which is caused by a driving force of a drive apparatus of the valve, and which lifting movement is oriented in the axial direction of a main axis, in a closed position, in which the valve bears with its closing surface against the valve seat and thereby separates the feed channel from the valve chamber in a fluid-tight manner, or in at least one open position raised from the valve seat and thereby releasing a fluid connection between the feed channel and the valve chamber in permanent fluid connection with the working channel and wherein the valve member is constantly biased in the direction of the closed position by a closing spring of a spring apparatus of the valve, wherein in addition to the closing spring, the spring apparatus has an opening spring which constantly biases the valve member in the direction of the at least one open position, wherein the closing spring and the opening spring, which acts in the opposite direction in this respect, are mutually coordinated with respect to their spring forces in such a way that the valve member takes up a basic position without driving forces of the drive apparatus, which basic position is an intermediate open position lying between the closed position and a maximum open position.

2. The valve according to claim 1, wherein the drive apparatus is of an electrically actuatable type.

3. The valve according to claim 1, wherein the drive apparatus is configured as an electrodynamic drive apparatus.

4. The valve according to claim 1, wherein the drive apparatus comprises a first drive component formed by an electrical coil apparatus and a second drive component interacting with the electrically powered electrical coil apparatus to generate a driving force acting on the valve member in the axial direction of the main axis, wherein one of the two drive components is positioned on the valve member and the other of the two drive components is positioned on the valve housing.

5. The valve according to claim 2, wherein the valve comprises a control electronics configured to control the drive apparatus.

6. The valve according to claim 5, wherein the control electronics is configured to electrically power the drive apparatus, wherein both an opening current direction acting on the valve member and a closing current direction acting on the valve member can be generated by the control electronics in the drive apparatus.

7. The valve according to claim 1, wherein the valve comprises a position detection apparatus for detecting lifting positions of the valve member that can be reached during the lifting movement.

8. The valve according to claim 1, wherein, in the intermediate open position, the valve member releases a flow cross-section for the fluid passing through the feed channel opening which is at least essentially half as large as a maximum flow cross-section released in the maximum open position of the valve member.

9. The valve according to claim 1, wherein the closing spring and the opening spring are each a compression spring.

10. The valve according to claim 1, wherein the closing spring and the opening spring are each a coil spring.

11. The valve according to claim 1, wherein the closing spring and the opening spring have force-displacement characteristics and/or winding pitches that are matched to one another.

12. The valve according to claim 1, wherein the closing spring and the opening spring are configured as separate, individual springs of the spring apparatus.

13. The valve according to claim 12, wherein of the closing spring and the opening spring, one of the two springs coaxially encloses the other of the two springs. 14. The valve according to claim 12, wherein the valve member comprises a hat-shaped anterior end section with a front ground wall comprising the closing surface, a sleeve-shaped sidewall extending axially away from the feed channel opening starting from the front of the ground wall and an annular disc-shaped support wall projecting radially outwards from the sleeve-shaped sidewall at an axial distance from the front ground wall, wherein the closing spring is enclosed by the sleeve-shaped sidewall and is supported on the one hand on the ground wall of the valve member and on the other hand on an axially opposite housing-fixed support body and wherein the opening spring surrounds the sleeve-shaped sidewall and is supported within the valve chamber on the one hand on the valve housing and on the other hand on the support wall of the valve member.

15. The valve according to claim 1, wherein the valve member comprises a valve member base body, on the front side of which facing the feed channel opening a separate sealing element of the valve member comprising the closing surface is positioned.

16. The valve according to claim 1, wherein the closing surface is formed on a sealing element of the valve member consisting of a rubber-elastic material.

17. The valve according to claim 1, wherein the valve is configured as a 2/2-way valve.

18. The valve according to claim 1, wherein the valve seat framing the feed channel opening is formed on a sleeve-shaped valve seat element which is separate with respect to the valve housing, is aligned coaxially with the main axis, is inserted into an inner end section of the feed channel with a variable axial position with respect to the main axis and is fixed to the valve housing in a manner fixed to the housing.

19. The valve according to claim 1, wherein the valve member comprises a compensation surface which is oriented axially opposite to the closing surface and which compensation surface delimits a compensation chamber formed in the valve housing, which compensation chamber constantly communicates with the region axially upstream of the closing surface via at least one compensation channel passing through the valve member and opening out with at least one compensation opening at the closing surface.

20. The valve according to claim 7, wherein a position-controlled actuation of the drive apparatus can preferably be carried out on the basis of position data obtained by means of the position detection apparatus.
